(19) United States
(12) Patent Application Publication
(10) Pub. No.: US 2025/0250696 A1
(43) Pub. Date: Aug. 7, 2025

(54) MODULAR-STACKABLE-LONG DURATION STORAGE THROUGH HYDROGEN PRODUCTION

(71) Applicant: Exowatt, Inc., Miami, FL (US)

(72) Inventors: Sushrut Bapat, Miami, FL (US); Pedro Neves, Miami, FL (US); Kiran Kambly, Miami, FL (US); Ehsan Ordouie, Miami, FL (US); Hannan Parvizian, Miami, FL (US); John M DeLappe, Miami, FL (US)

(21) Appl. No.: 19/043,411

(22) Filed: Jan. 31, 2025

Related U.S. Application Data
(60) Provisional application No. 63/549,410, filed on Feb. 2, 2024.

(51) Int. Cl. C25B 9/67; C25B 1/042; C25B 15/021; C25B 15/08

(52) U.S. Cl. CPC C25B 9/67; C25B 1/042; C25B 15/021; C25B 15/083

(57) ABSTRACT

Hydrogen is produced using high temperature heat from a progressive heat collection system that utilizes sun and air for collection and transfer of heat. Thermal energy from the sun superheats the water into steam and also powers a Stirling engine based electrical generator for operating a high temperature steam electrolyzer.

### CROSS-REFERENCES TO RELATED APPLICATIONS

Benefit is claimed from U.S. Provisional Patent Application No. 63/549,410 filed Feb. 2, 2024, incorporated herein by reference in its entirety and for all purposes.

### STATEMENT REGARDING FEDERALLY SPONSORED RESEARCH OR DEVELOPMENT

None.

### FIELD

The technology herein relates to hydrogen production using high temperature heat from a sequential heat collection system that utilizes sun and air for collection and transfer of heat. The technology further relates to a modular approach to such a sequential heat collection system.

### BACKGROUND

Hydrogen is a building block for a variety of fuel types, including ammonia and syngas. It is also an important component for steel manufacturing. While hydrogen presents one of the few pathways towards realization of a carbon-free economy, hydrogen production is presently cost prohibitive unless produced through fossil fuel derived processes such as methane reforming. Although ongoing research and development and the exponential deployment of PV solar and wind have increased the cost competitiveness of hydrogen production through renewable energy sources; it is still not sufficient to justify as a sustainable pathway for hydrogen production.

It is known that Hydrogen can be generated efficiently with high-temperature electrolysis. The process generally needs steam at temperatures of 850 to 950 deg C. Typically this higher temperature heat is supplied by fossil fuel or nuclear power plants.

One promising technology is the Solid Oxide Electrolysis Cell (SOEC). While SOEC provides high efficiency (up to 100%) of converting fuel to hydrogen, it can only be realized for low cost hydrogen production when coupled with a low-cost heat and electricity source. With operating temperatures of 750 to 800° C., the energy demand for SOEC derived hydrogen production techniques is considerably high, affecting the growth and deployment of this promising technology.

Several conceptual studies have been presented to demonstrate the ability of the concentrated solar power (CSP) technologies to couple with the SOEC systems, to supply heat and power through integrated thermal storage systems. The integration provides low-cost electricity with a high-temperature heat source for the SOEC systems. Analysis has shown that a solar to hydrogen conversion efficiency of 18% is practically achievable with such an integration. Unfortunately, the state-of-the-art CSP technologies are either enormous to build or require a rather large capital investment to warrant deployment for hydrogen production.

### BRIEF DESCRIPTION OF THE DRAWINGS

The patent or application file contains at least one drawing executed in color. Copies of this patent or patent application publication with color drawing(s) will be provided by the Office upon request and payment of the necessary fee . . . . Features and advantages of example embodiments will be better and more completely understood by referring to the following detailed description of exemplary non-limiting illustrative embodiments in conjunction with the drawings of which:

FIG. 1 is a schematic diagram of a system.

FIG. 1A(1), 1A(2), 1A(3) together are a more detailed schematic diagram of the system.

FIG. 2 shows a more detailed view of a heat collection module.

FIGS. 3A-3F show different views of a practical implementation.

FIGS. 3G-3H show a continuous absorber design.

FIG. 4 shows an example SOEC stack.

FIG. 5 shows example energy balance plotted across month of the year for Idaho Falls, ID,

FIG. 6(A) shows an example optical model.

FIG. 6(B) Optical system effectiveness in Idaho Falls, ID.

FIG. 6(C) CFD plot showing exit air temperature from collector.

FIG. 6(D) shows example fluid temperature from TESS.

### DETAILED DESCRIPTION OF EXAMPLE NON-LIMITING EMBODIMENTS

Example embodiments provide high temperature heat using a sequential and/or progressive heat collection system for use in generating hydrogen. The system utilizes sun and air for collection and transfer of heat to provide a 100% renewable and green-house-gas emission free hydrogen generation system.

One example embodiment provides a system comprising: a solar heating stage providing a medium heated by solar energy; a heat exchanger thermally-coupled to receive the heated medium, the heat exchanger using the heated medium to generate steam; a thermal engine thermally connected to receive the heated medium, the thermal engine generating electricity in response to the heated medium; and an electrolyzer coupled to the heat exchanger and to the thermal engine, the electrolyzer using the electricity generated by the thermal engine to electrolyze the steam.

The electrolyzer comprises an SOEC.

A separator connected to the electrolyzer separates hydrogen gas from water output by the electrolyzer, the separated water being directed to the heat exchanger.

A further heat exchanger removes heat from the hydrogen gas and water.

A compressor compresses the separated hydrogen gas.

Ducting supplies the heated medium to the electrolyzer, and supplies the heated medium after passing through the electrolyzer to the thermal engine.

A thermal storage is connected between the solar heating stage and the heat exchanger.

A second heating stage thermally coupled to receive the heated medium, further heats the heated medium output to provide a cumulatively heated medium to the heat exchanger.

The heating stage and the second heating stage each comprise solar heating stages of a continuous solar heat absorber.

A further heat exchanger removes heat from oxygen gas generated by the electrolyzer.

A method comprises providing a medium heated by solar energy; using the heated medium to generate steam; generating electricity in response to the heated medium; and using the generated electricity to electrolyze the steam.

The electrolyzer comprises an SOEC.

Hydrogen gas is separating from water and the separated water is used to generate more steam.

Heat is removed from the hydrogen gas and water.

The separated hydrogen gas is compressed.

Ducting supplies the heated medium to the electrolyzer, and the heated medium after passing through the electrolyzing to generates electricity.

A thermal storage connected between the solar heating and the steam generation stores heat.

The heated medium is cumulatively heated with multiple solar heating stages.

Heat from oxygen gas generated by the electrolyzing is removed.

One example embodiment provides a system comprising: a first heating stage providing a first heated medium output; a second heating stage thermally coupled to receive the first heated medium output, the second heating stage further heating the first heated medium output to provide a second, cumulative heated medium output; a heat exchanger thermally-coupled to receive the second, cumulative heated medium output, the heat exchanger using the second heated medium output to provide heated steam; and an electrolyzer coupled to the heat exchanger, the electrolyzer performing electrolysis to produce hydrogen from the heated steam. The first heating stage and the second heating stage may each comprise solar heating stages that are part of a progressive solar heating system.

In more detail, an example embodiment provides a hydrogen generation system design. Hydrogen generation is performed using high-temperature steam electrolysis. The sequential collection system is utilized to collect extreme temperature heat. The collection system comprises of a series of Frensel lenses and an associated progressive absorber that achieves the high-temperature heat collection. Example embodiments provide a fully-renewable hydrogen generation system, high-temperature heat, and electricity delivery for hydrogen production.

An example non-limiting design delivers cost-effective technology for high-temperature heat capture with a Fresnel Lens concentrator, a continuous stainless steel absorber, an inline porous-clay block based thermal energy storage system (TESS) and a hot-air operated Stirling engine. The system contains two independent loops: charging and discharging. The Fresnel Lens concentrator is mounted in a single-axis tracker that can provide up to 80% optical system effectiveness when compared to classical dual-axis tracker, however, with substantially reduced mechanical complexity. In one embodiment, each module delivers 5 kW of electric power for 8 hours per day. The module contains built-in cartridge heaters to assist TESS to hold charge level during days where the solar resource is limited or unavailable.

### Example Schematic Diagram of System

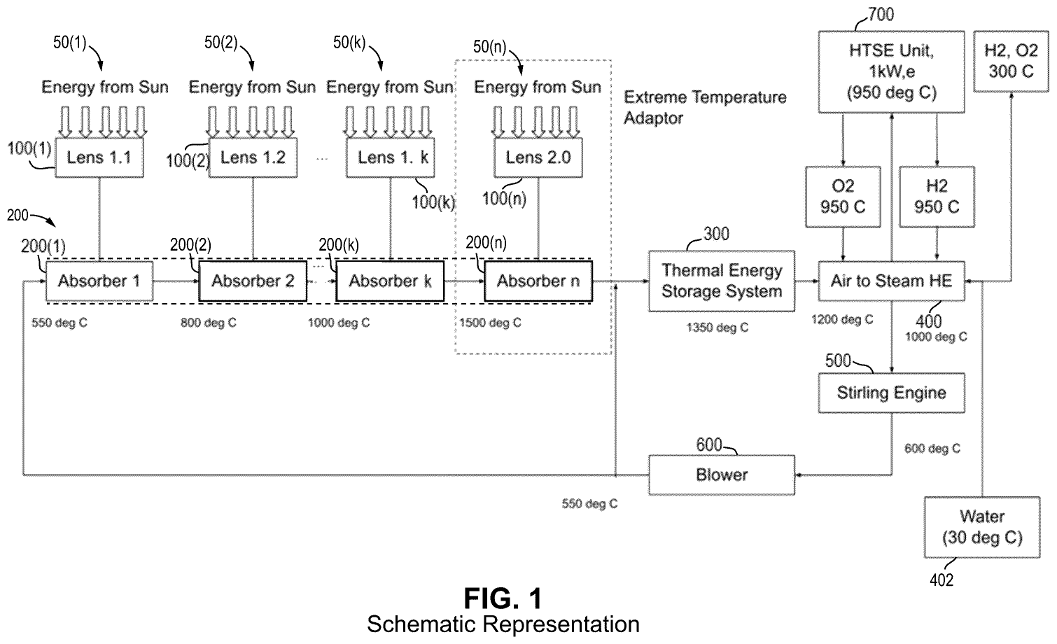

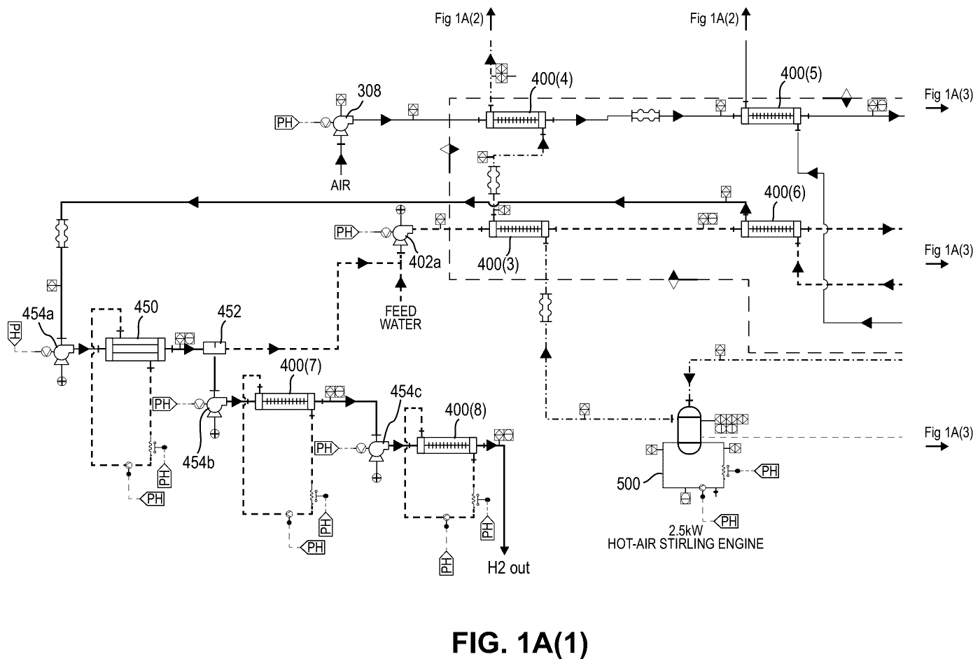

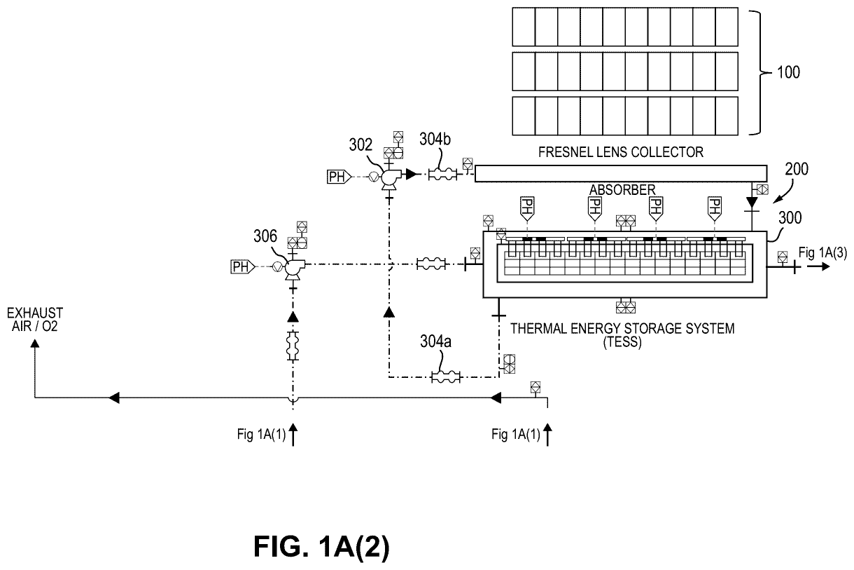

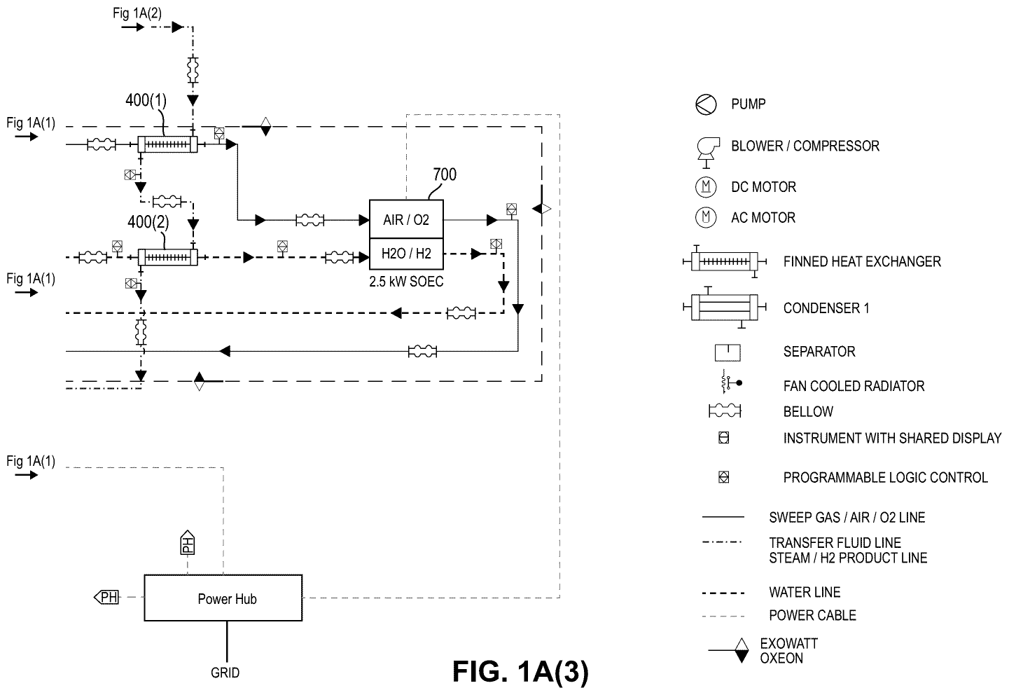

FIG. 1 is a schematic view of an example non-limiting system with a series of k solar thermal collector stages 50(1), 50(2), . . . , 50(k). Each solar collector stage comprises a respective solar collecting lens arrangement such as a Fresnel lens panel 100 and a respective associated heat absorber stage 200. Each respective lens arrangement 100 focuses the sun's energy onto a respective heat absorber stage 200. In the example shown, the respective lenses/heat absorber stages 100/200 are arranged in a sequence of progressive heating stages. The first stage comprising lens 100(1) and heat absorber stage 200(1) provides a heat output (e.g., via ducted media such as a gas) at a first target temperature such as 800 degrees Centigrade. The second stage comprising lens 100(2) and heat absorber stage 200(2) is connected to receive the heat output of the first stage, and further incrementally heats the heated media using additional thermal energy collected from the sun to a higher temperature such as 1000 degrees Centigrade. A kth stage comprising a lens 100(k) and a heat absorber stage 200(k) collects additional thermal energy from the sun to raise the temperature of the already-heated media to a further, incrementally higher temperature such as 1500 degrees Centigrade. There can be as many stages 100/200 as desired stacked or sequenced in this manner to progressively raise the temperature of the heated media to a desired temperature. In other words, k can comprise any non-negative integer such as 0, 1, 2, 3, . . . . As noted below, the heat exchanger stages can be continuously defined with or without discrete absorbers (i.e., a continuous absorber can be used) to provide a desired continuously progressive heating effect.

In one example embodiment, the thermal collector stages 100(1)/200(1), 100(2)/200(2), etc. are identical in construction and operation, and can withstand the highest temperature in the progressive heating sequence. In other embodiments, stages operating at lower temperatures can be made of less rugged materials than stages operating at higher temperatures.

In the example shown, a late stage(s) comprising a respective lens 100(n) and respective absorber stage 20(n) may comprise different structures that can withstand very high temperatures (e.g., 1500 degrees C.). There may be more than one late stage or as many late stages as needed to raise the temperature of the media to a desired extremely high temperature to provide to a thermal energy storage system (“TESS”) 300. In one example embodiment, the thermal energy storage system 300 can comprise a block of clay, graphite or other thermal mass within a housing.

In the example shown, the thermal energy storage system 300 outputs thermal energy to an air-to-steam heat exchanger 400 and to a Stirling engine 500. The Stirling engine 500 converts heat from the thermal energy storage system 300 into electricity which is supplied to a high temperature steam electrolyzer 700. In the embodiment show, the air or other fluid exhaust of Stirling engine 500 is recirculated via a blower or pump 600 to the TESS 300. The TES 300 in turn may recirculate heated medium to staged heat collectors so the first stage 50(1) receives preheated media (e.g., at 550 degrees C.) as a starting point.

The air to steam heat exchanger(s) 400 uses thermal energy supplied by the final stage absorber 200(n) via the TESS 300 to convert water into high temperature steam at a temperature such as 850 to 950 deg C. that sustains high efficiency electrolysis. The electrolyzer 700 uses electricity the Stirling engine 500 produces to electrolyze such superheated high temperature steam into its elemental H₂ and O₂ components. The result of the electrolysis performed by electrolyzer 700 is hydrogen gas (H₂) and oxygen gas (O₂) that can each be harvested separately from different electrodes of the high temperature steam electrolyzer (HTSE) 700.

Conventional hydrogen electrolyzer 700 in one embodiment comprises a solid oxide electrolysis cell (SOEC) consisting of an anode, a cathode, and an electrolyte. The electrolyte may for example comprise a solid ceramic material and the anode and cathode may be made from special inks that coat the electrolyte and facilitate an electrochemical pathway to produce hydrogen and oxygen. High operating temperatures of such a solid oxide cell provides a greater overall efficiency than alternative technologies, requiring far less electricity to facilitate the redox reaction that separates H₂O into H₂ and O₂. See e.g., Hauchet al “Highly Efficient high temperature electrolysis”. J. Mater. Chem. 18 (20): 2331-2340 (2008). doi: 10.1039/b718822f; Mougin et al, Enhanced Performance and Durability of a High Temperature Steam Electrolysis Stack, 10th European SOFC Forum 2012 Jun. 26-29, 2012, doi.org/10.1002/fuce.201200199; Liepa et al, High-temperature steam electrolysis: Technical and economic evaluation of alternative process designs International Journal of Hydrogen Energy, Volume 11, Issue 7, 1986, Pages 435-442.

Heat is carried by air or other transport medium from the heat absorber 200(n) (i.e., the end of the heat absorber chain) to the thermal energy storage system 300. The TESS 300 stores some of this heat and the rest is delivered to the air to steam heat exchanger(s) 400. The air to steam heat exchanger(s) 400 uses the heat supplied to it to convert feed water 402 into saturated superheated steam. This steam enters the electrolyzer 700, recuperator circuit and in one embodiment also cycles back to a secondary air to steam heat exchanger 400 to collect the remainder of the heat to take the steam to the desired 950 deg C. The air from the heat collection system is then supplied to inline power conversion unit 500 that converts the thermal energy carried by the air to electricity and low temperature heat.

In one embodiment, one or plural Stirling engine(s) 500 is used as inline power conversion unit(s) 500. Electricity generated by the power conversion unit 500 is utilized to operate the electrolyzer 700 that splits the incoming steam to hydrogen and oxygen. High temperature hydrogen and oxygen then passes through the recuperators and exit the system at 300 deg C. hydrogen and oxygen gases for downstream heat delivery and storage.

### Example More Detailed Schematic Diagram of System

FIG. 1A(1), 1A(2), 1A(3) together show a more detailed schematic diagram of a system embodiment. In this example, Fresnel lens collector panel(s) 100 focus radiant solar energy onto an absorber structure(s) 200 respectively thermally coupled to segments of a segmented or stacked TESS 300. A circulation system including a blower 302 circulates heated air from the absorber structure(s) 200 to the TESS 300 (bellows 304 may be located in the ducting used for such circulation) and from the TESS back to the absorber structure(s).

FIG. 1A further shows an SOEC type electrolyzer 700 which receives (a) heated air, (b) superheated steam (H₂O), and (c) electricity, and outputs (d) oxygen gas (O₂) and (e) hydrogen gas (H₂) split from the superheated steam (H₂O). Heated air is supplied to the SOEC 700 to preheat it, act as a sweep gas to sweep oxygen on the anode side, and help regulate temperature within the cell. Steam is fed into a porous cathode of the SOEC 700. When a voltage is applied, the steam moves to the cathode-electrolyte interface and is reduced to form pure H₂ and oxygen ions. The H₂ hydrogen gas then diffuses back up through the cathode and is collected at its surface, while the oxygen ions are conducted through the dense electrolyte. The electrolyte is dense enough so the steam and hydrogen gas cannot diffuse through and lead to the recombination of the H₂ and O₂. At the electrolyte-anode interface, the oxygen ions are oxidized to form pure O₂ oxygen gas, which is collected at the surface of the anode. See e.g., Ni et al, “Technological development of hydrogen production by solid oxide electrolyzer cell (SOEC)”. International Journal of Hydrogen Energy. 33 (9): 2337-2354. (2008) doi: 10.1016/j.ijhydene.2008.02.048.

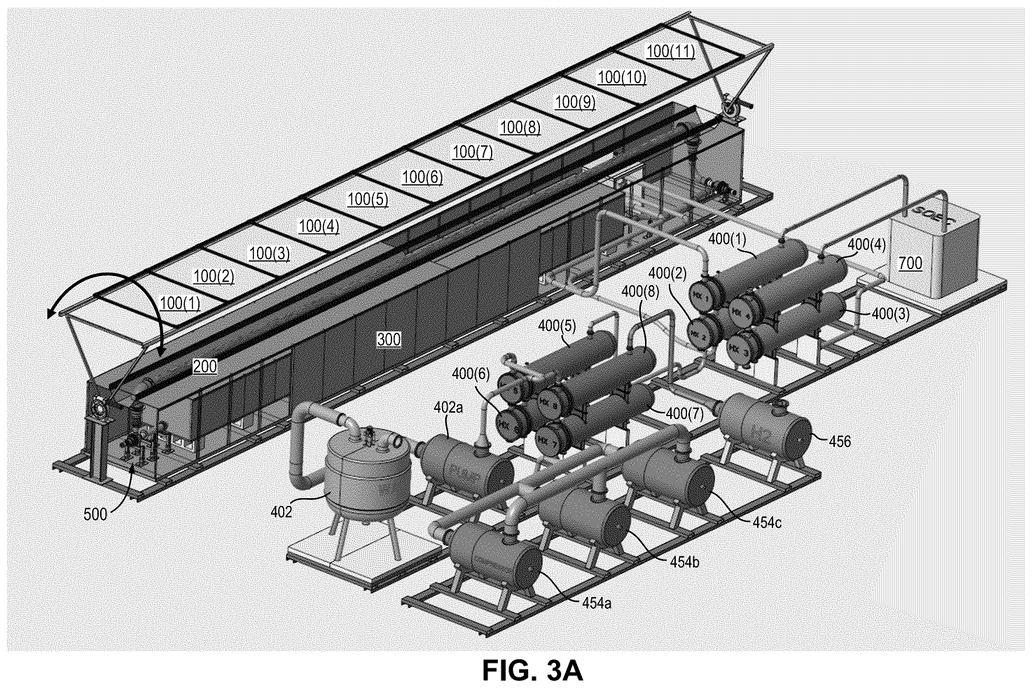

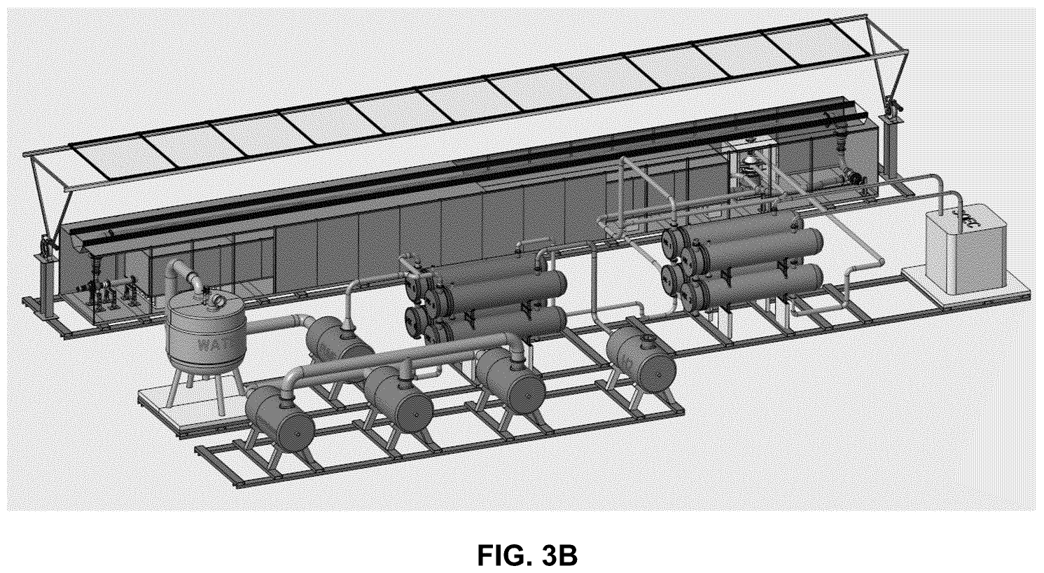

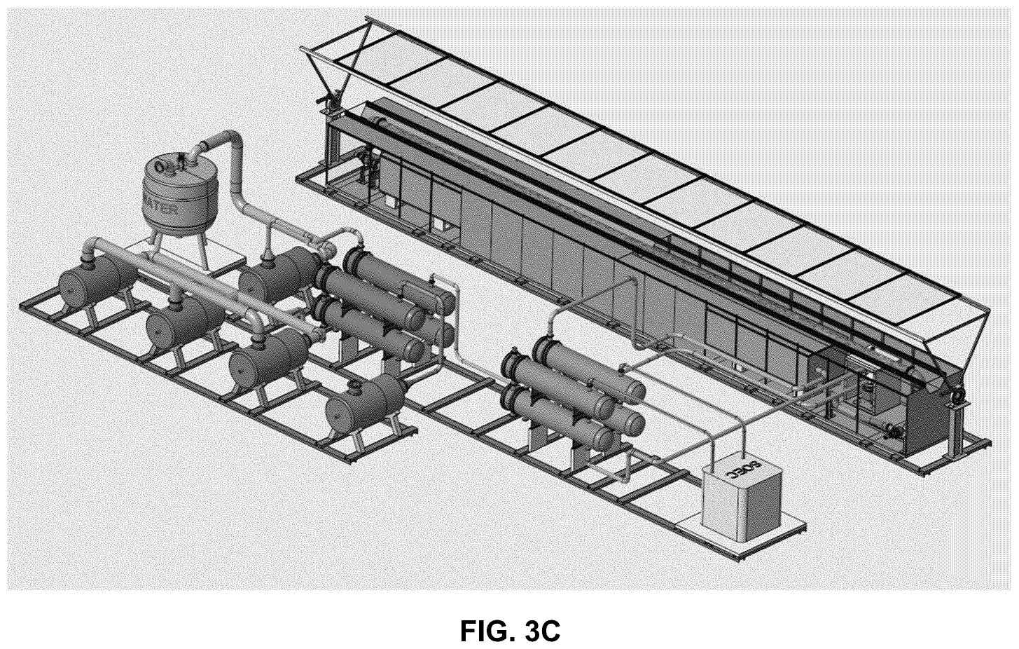

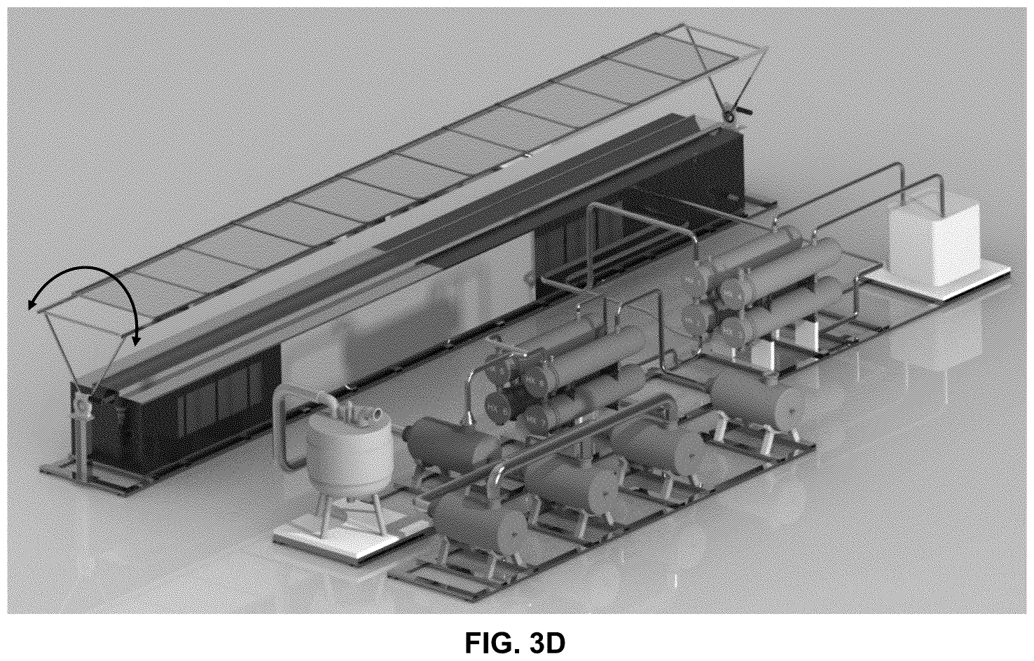

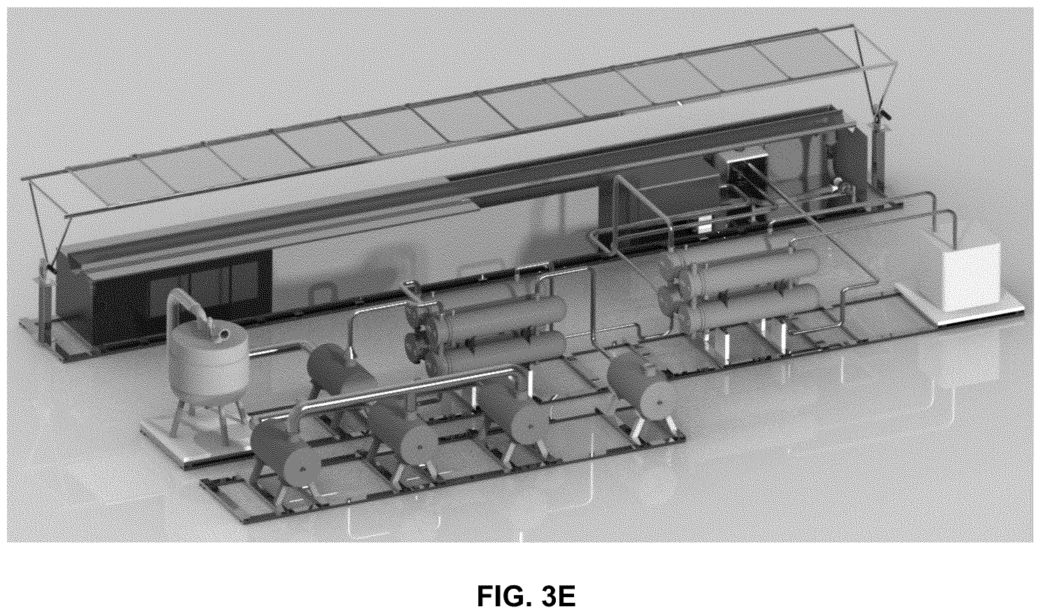

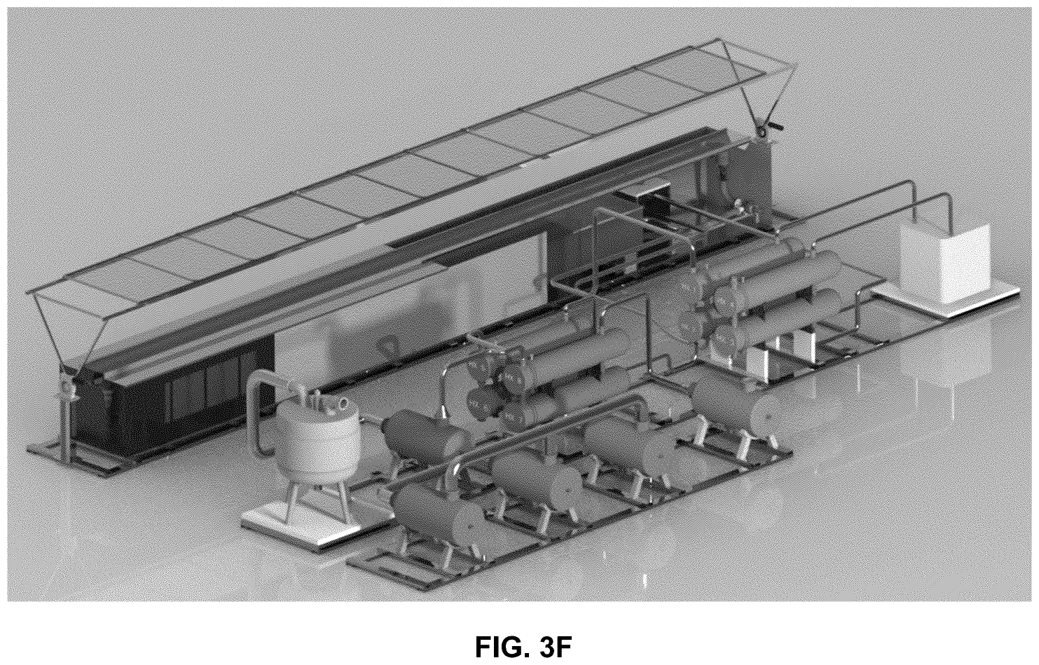

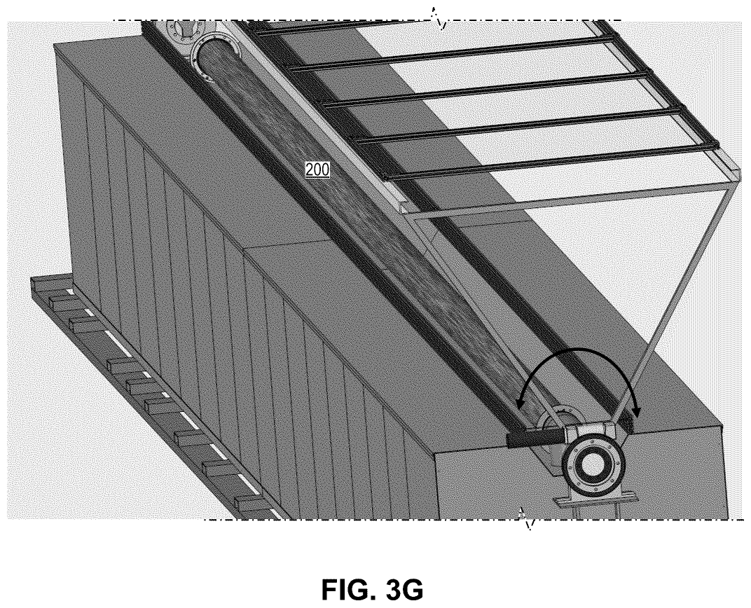

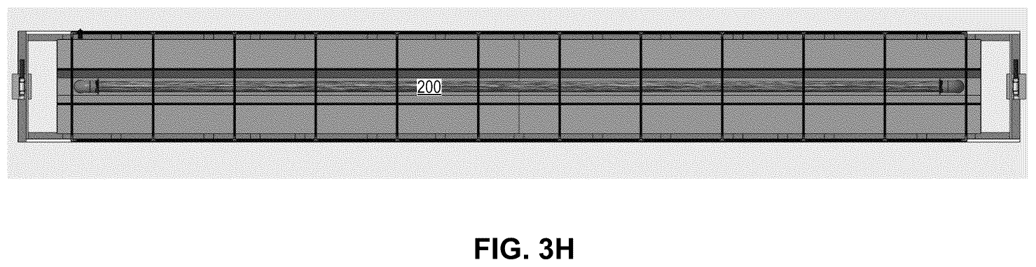

In the example system shown, a hot air circulation path is provided from TESS 300 through heat exchangers 400(1), 400(2), then through stirling engine 500, and finally through heat exchangers 400(3), 400(4) and back through blower 306 to the TESS. Heat exchangers 400(1), 400(4) heat air being supplied to SOEC 700, and heat exchangers 400(2), 400(3) heat water being supplied to the SOEC. In the example shown, the heated O2 output of SOEC 700 passes through heat exchanger 400(5) which is connected in series with heat exchangers 400(4), 400(1) to harvest heat from the O₂ SOEC output to further heat the air being input to the SOEC. The O₂ and air once cooled in this fashion can be exhausted to the environment. The heated H₂ output of SOEC 700 meanwhile passes through heat exchanger 400(6) which is connected in series with heat exchangers 400(3), 400(2) to harvest heat from the H₂ SOEC output to further heat the water being input to the SOEC. This secondary air to steam heat exchanger 400(6) collects the remainder of the heat to take the steam to the desired 950 deg C. A compressor 454a and condensor 450 condenses steam that has passed through heat exchanger 400(6) into water. A separator 452 separates this condensed water from H₂ gas. The separated water is reused as feed water 402 and is pumped back into the SOEC 700. The separated H₂ gas passes through additional compressors 454b, 454c and respective heat exchangers 400(7), 400(8) to remove additional heat it carries to compress it into a liquid for storage in a storage tank 456 (see FIG. 3A).

The example embodiment thus provides different heat transfer circuits or paths for air/O2 circulation and water/H₂ circulation, respectively. As noted above, the heated air after passing through the SOEC 700 is supplied to inline power conversion unit 500 that converts the thermal energy carried by the air to electricity, which in turn is supplied to the SOEC 700 to create electrolysis.

### Another View of a Solar Platform Portion

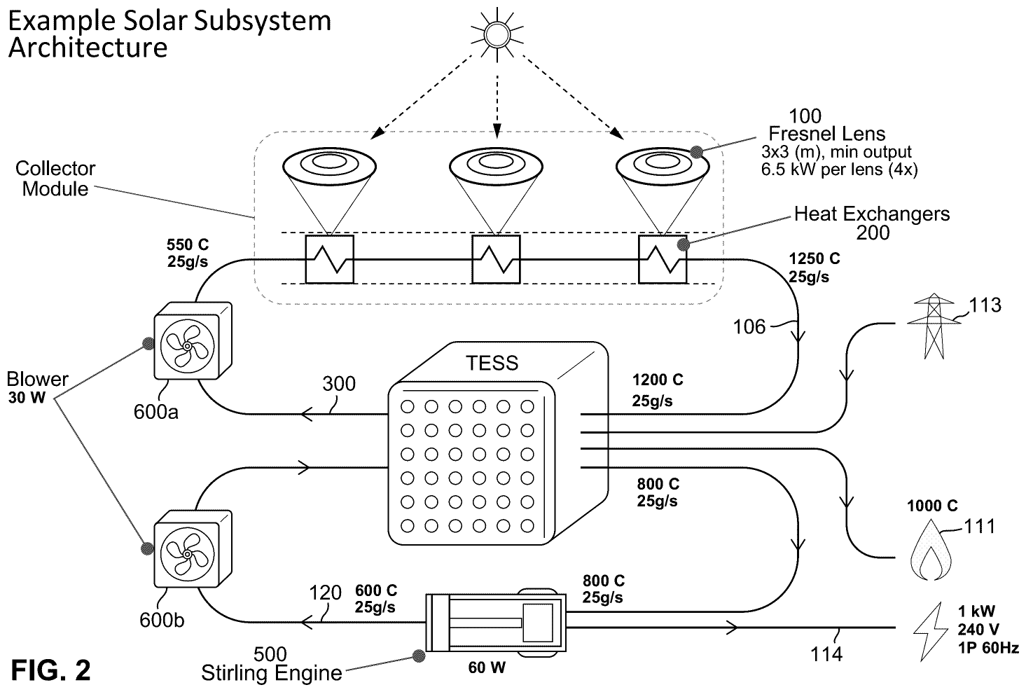

FIG. 2 shows another view of an example embodiment of a progressive heat-collection system design suitable for use in the FIG. 1 hydrogen generation system. The Figure system utilizes a combination of one or more Fresnel lenses 100 and associated heat absorbers 200 to collect high-temperature heat. Solar energy incident on each Fresnel lens 100 is concentrated on an associated absorber stage 200. In one embodiment, absorber 200 consists of or comprises a linear, continous insulated-multi-channel heat exchanger that transfers this concentrated heat to transfer fluid that flows through the system's ductwork 106. The transfer fluid flowing through ductwork 106 carries and delivers the heat to a thermal energy storage system (“TESS”) 300, where it can be stored for long duration periods.

The heat stored in the thermal energy storage system 300 can then be dispatched to a power conversion system 110 but in this case is dispatched as high quality temperature (e.g., 1000 degrees C.) heat 111 for converting air to steam as explained above. Also shown in FIG. 2 is an electrical input 113 from the power grid that can be used to generate heat (e.g., through conventional resistive heating elements) to heat the TESS 300 when heat from the sun is inadequate.

After the power conversion system 110 converts heat to electricity, the remaining heat in the transfer fluid exits the power conversion system with a lower temperature at 120 degrees C. and is circulated back to the progressive heat-collection system or to the TESS 300 for continuous recycling. One or more blowers or pumps 600 may be used to provide circulation and recirculation. In particular, the output of blower 600b shown can be directed to either the TESS 300 or to the chain of thermal collectors 100/200 or both.

In one embodiment, the thermal energy storage system 300 contains insulated thermal energy blocks that are arranged in series/parallel configuration to store the energy required for off-sun hours of system operation.

In one embodiment, the power conversion system comprises one or more Stirling engines 500 that accept the heat from the incoming transfer fluid and convert it to electricity 114 and low-temperature heat. As noted above, the electricity 114 can be used to provide electrolysis of steam also produced by heat from the solar collection system.

The sequential or progressive nature of heat collection allows the system to be scalable for any power conversion unit capacity. The system is extremely flexible in layout and modular for ease of integration and installation.

For example, although FIG. 2 shows three Fresnel lens/absorber 100/200 stages, there can be any number of such combinations such as one Fresnel lens/absorber stage 100/200, two Fresnel lens/absorber stages 100/200, three Fresnel lens/absorber stages 100/200, four Fresnel lens/absorber stages 100/200, five Fresnel lens/absorber stages 100/200, six Fresnel lens/absorber stages 100/200, . . . , or N Fresnel lens/absorber stages 100/200 where N is any positive integer. In the example shown, the thermal fluid flows through the three Fresnel lens/absorber stages 100/200 in series, but in other embodiments the thermal fluid can flow through such units in parallel, or some of the thermal fluid can flow through two or more such units in series whereas other thermal fluid can flow through such units in parallel to provide a series-parallel combination. The number of such Fresnel lens/absorber stages 100/200 can be determined by the power output required. In the example shown, the configured is 3×3 (m) with a minimum output of 6.5 KW per lens (4×) but other configurations are possible depending on particular requirements. In one embodiment this is implemented by making a continuous linear absorber 200 a desired length and providing enough frame-mounted Fresnel lenses to illuminate that desired length with focused solar energy.

In one embodiment, the thermal collectors 100/200 provide a modular arrangement where multiple thermal collections comprise or provide a module. In such embodiments, it is possible to swap out or interchange one module for another, to add modules or to subtract modules.

### 3D Views of Example System Implementation

FIGS. 3A-3F show different views of the example FIG. 1A modularized combined high-temperature heat, hydrogen, and power (CHHP) delivery system. It integrates a linearly scalable concentrated solar power (CSP), combined high-temperature heat, and power (CHP) delivery system, with a 2.5 kW high-temperature solid-oxide electrolysis stack 700 to provide a modularized CHHP solution. The solution provides hydrogen generation at $1.50 per kg with a capacity factor of up to 100%.

The system shown integrates a solar generation system with a larger TESS 300, smaller Power Conversion Unit (PCU) 500 and a 2.5 kW SOEC stack 700. This embodiment includes a continuous linear heat exchanger 200 disposed beneath a tracking frame moveable about a single axis containing an array of Fresnel lens panels 100(1), 100(2), 100(3), . . . , 100(11). A controller automatically rotates the single axis tracking frame about the axis of the continuous linear heat exchanger 200 as the sun moves in the sky to track the sun's position and continually focus the sun's rays onto the linear heat exchanger 200.

FIGS. 3G-3H detail an example continous absorber 200 design using a glass tube. In this design, the tube shape design provides more surface area (high absorptivity and high porosity), allowing it to absorb light more effectively at different angles due to its curved geometry.

The energy collected from the optical system is transferred to the heat transfer fluid through the porous heat exchanger 200 where the transfer fluid exit temperature is at 1200° C. or above. To accommodate for the variability in the solar resource, the transfer fluid flow rate is modulated to maintain the desired exit temperature. The transfer fluid transfers this energy to the TESS 300 through a porous-clay block heat exchanger/storage for further use.

High temperature heat is delivered to the SOEC 700 section wherein it will add all necessary thermal energy for producing 1.5 kg/day. Transfer fluid exiting from the SOEC section 700 will then enter the hot-air Stirling engine 500 where it will generate the electrical energy required to operate the hydrolysis provided by the SOEC stack 700. Exit from the Stirling engine 500 will pass through a heat exchanger to preheat feed water and sweep gas.

Alternative solar platforms may be used with the hydrogen generation system described above. See for example U.S. patent application No. 63/692,688 filed Sep. 9, 2024; and application No. 63/692,686 filed Sep. 9, 2024 (“Solar Collection Platform”), each of which are expressly incorporated by reference herein for all purposes. Such solar platform can be substituted for the example solar platform shown in FIG. 2 and on the lefthand side of FIG. 3A and following.

### Example SOEC Stack

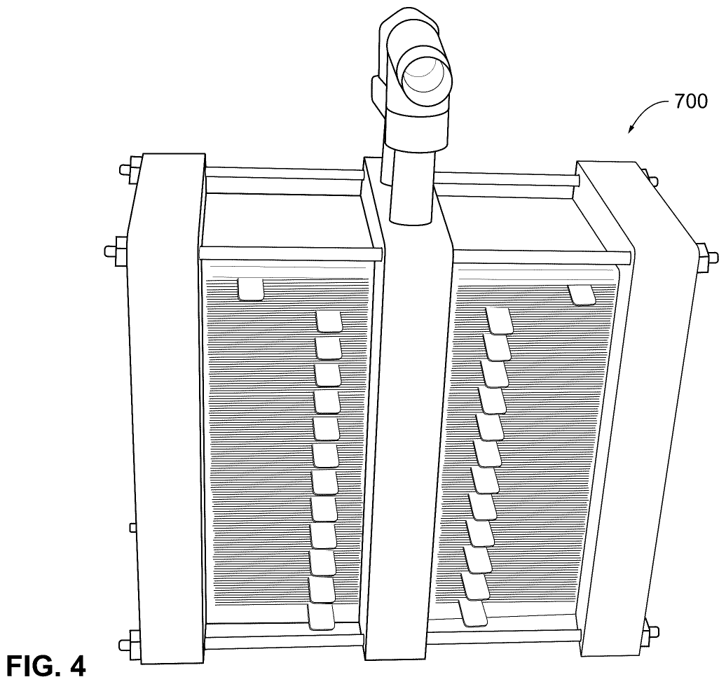

One example embodiment uses a SOEC stack 700 shown in FIG. 4. This SOEC stack 700 provides an electrolyte-based cell design with fuel electrode and air electrodes of particular compositions. Conventional liquid-phase water electrolysis requires from 50-58 kWhₑ/kg of H₂, while high-temperature steam electrolysis requires 35-37 kWhₑ/kg of H₂. Thermodynamic benefits of high temperature SOEC 700 include operating at a thermoneutral voltage (Vtₙ) that is well below the typical operating voltage of current-day low temperature Proton-Exchange Membrane (PEM) and alkaline electrolysis devices. Because the thermodynamic open circuit voltage drops with increasing temperature, high temperature operation allows greater driving potential for current, and if greater than Vtₙ, also provides heating of reactant streams.

### System Efficiency

In one embodiment, the electrolyzer loop contains the water, sweep gas, steam and hydrogen sections (see FIG. 3A et seq). Loop efficiency is calculated using the energy delivered to the loop vs energy lost from the loop to the ambient. These losses can comprise the energy content in the sweep gas at exhaust, energy content in hydrogen product before compression and energy lost through insulation. Efficiency may be as high as 92%. The estimated losses are 2.5% lower than an equivalent CSP integrated hydrogen production device with trim heaters.

The system can attain a capacity factor of up to 100% with an average H₂ generation cost of $1.50 per kg. Capacity factor is defined based on maximum possible hydrogen production to the actual delivered hydrogen production. Considering solar resource is limited through the year, the system will operate strategically throughout the year to minimize the hydrogen production costs. A combined capacity factor of 100% is expected with CSP only and CSP with grid assist modes resulting in 550 kg per year of hydrogen production at an average annual cost of $1.50 per kg.

For an ideal solar resource availability, the system is designed to operate with no net grid power draw with all of the high-temperature heat and electricity for SOEC 700 provided by the system itself. For situations where solar resource is unavailable or is limited, TESS 300 will be charged using low-cost grid electricity using built-in cartridge heaters. The system is arranged across two standard ISO intermodal shipping containers (not shown in CAD for ease of visualization).

Scalability-On-Demand. Traditionally CSP systems are custom designed to maximize solar potential at a project site leading to several years of project deployment. Example non-limiting embodiments herein on the other hand can be linearly scaled to satisfy end-use requirements providing unmatched optionality and scalability for end user deployments.

Table 1 below provides additional example technical data.

| Parameter | Value | | Parameter | Value | |
|---|---|---|---|---|---|
| H₂ production | 550 | kg/year | Heat Transfer | Air | |
| | | | Fluid | | |
| Foot print | 5 m × 12 m | | TESS | 850 to 1050° C. | |
| | (2× std. containers) | | temperature | | |
| SOEC | 800° | C. | TESS capacity | 200 | kWhₜ |
| operating | | | | | |
| temperature | | | | | |
| SOEC | 2 | bar | Rated electrical | 2.5 | kWₑ |
| operating | | | output | | |
| pressure | | | | | |
| SOEC voltage | Thermoneutral | | Rated assist | 40 | kWₑ |
| | | | heater input | | |
| Cathode Inlet | 2-5% | | Thermal output | 33 | MWhₜ |
| H₂O mole | | | (55° C.) | | |
| fraction | | | | | |
| H₂O utilization | 75% | | Cooling water | 40° | C. |
| fraction | | | supply | | |
| Anode inlet O₂ | 50% | | Cooling water | 55° | C. |
| mole fraction | | | return | | |
| Anode outlet | 50% | | Condenser | 5 | bar |
| O₂ mole | | | pressure | | |
| fraction | | | | | |
| Sweep gas | Air | | Intermediate | 10 | bar |
| | | | H₂ pressure | | |
| Sweep gas or | 30° | C. | Final H₂ | 20 | bar |
| water inlet | | | pressure | | |
| temperature | | | | | |

A three-dimensional non-sequential ray-tracing analysis can be performed to determine energy available from the optical device (Fresnel Lens). Heat collector and TESS can be modeled and analyzed using three-dimensional CFD to develop sub-system effectiveness for system modeling, shown in Table 2 below:

TABLE 2
Sub-system Effectiveness for Performance Modeling and Analysis

| Parameter | Value | Parameter | Value |
|---|---|---|---|
| Optical system | 0.46-0.65 | Stirling Engine efficiency | 0.35 |
| effectiveness | | | |
| Collector system | 0.78 | Fluid transfer effectiveness | 0.95 |
| effectiveness | | | |
| TESS effectiveness | 0.92 | Trim heat exchanger | 0.92, ea. |
| | | effectiveness | |

An energy balance is performed utilizing the subsystem effectiveness to determine the thermal energy storage capacity of TESS and subsequently the optical device layout. Table 3 below summarizes the results.

TABLE 3
Energy Balance Results

| Parameter | Value | | Parameter | Value |
|---|---|---|---|---|
| H₂ production | 1.5 | kg/day | SOEC energy | 33 kWhₑ per kg |
| | | | consumption | of H₂ |
| Qᵢₙ, feed water | 0.68 | kWₜ | Auxiliary load | 12 kWhₑ per |
| to steam at | | | | day |
| 800° C. | | | | |
| Qᵢₙ, sweep gas | 0.24 | kWₜ | Optical collector | 60 m² |
| to 800° C. | | | area | |

| | | | |
|---|---|---|---|
| Qᵢₙ, TESS | 180 kWhₜ | Solar H₂ | 0.106 |
| | per day | efficiency | |

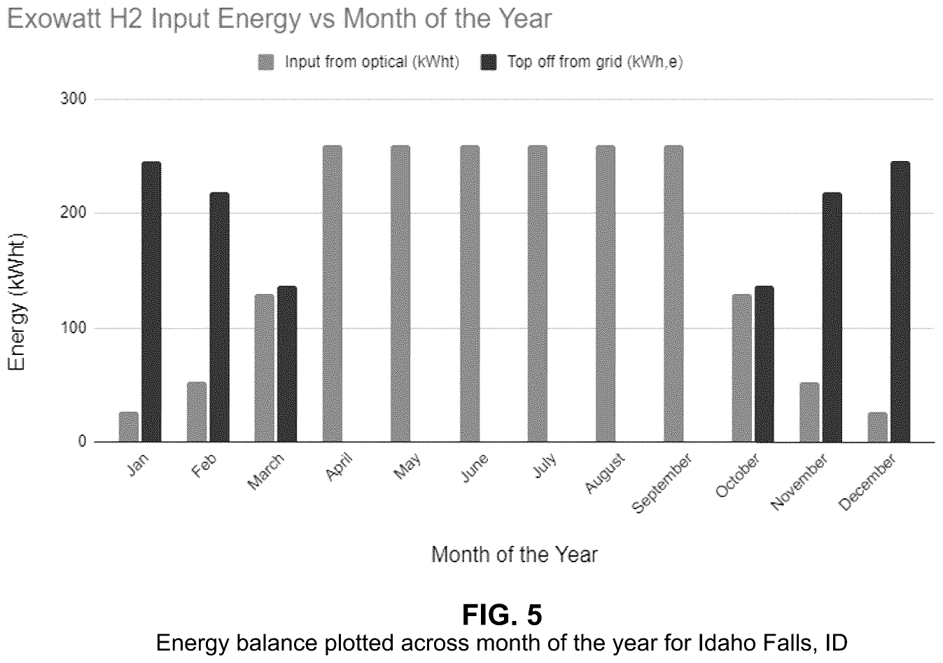

Energy balance for the example system is shown plotted in FIG. 5.

### Model Results

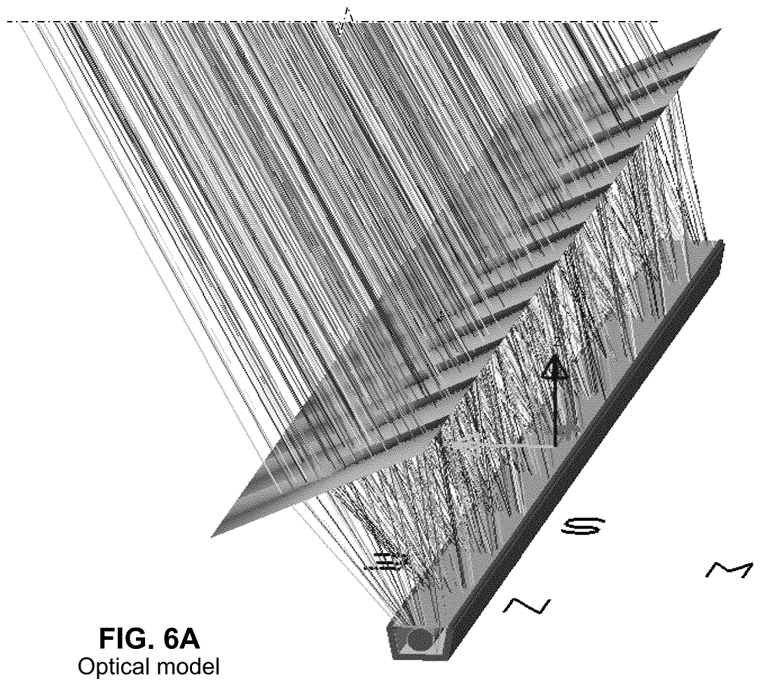

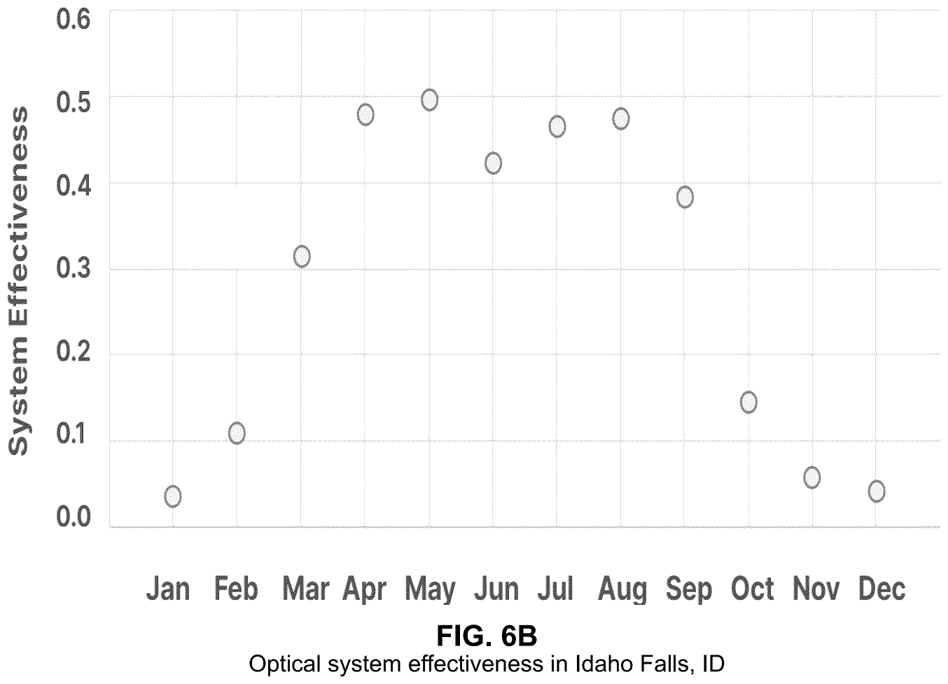

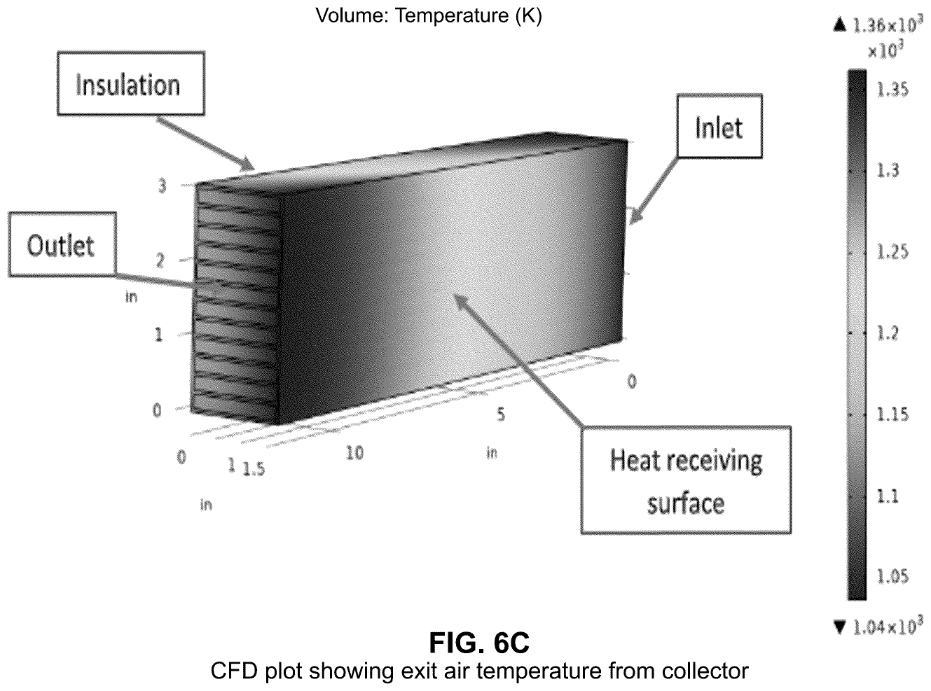

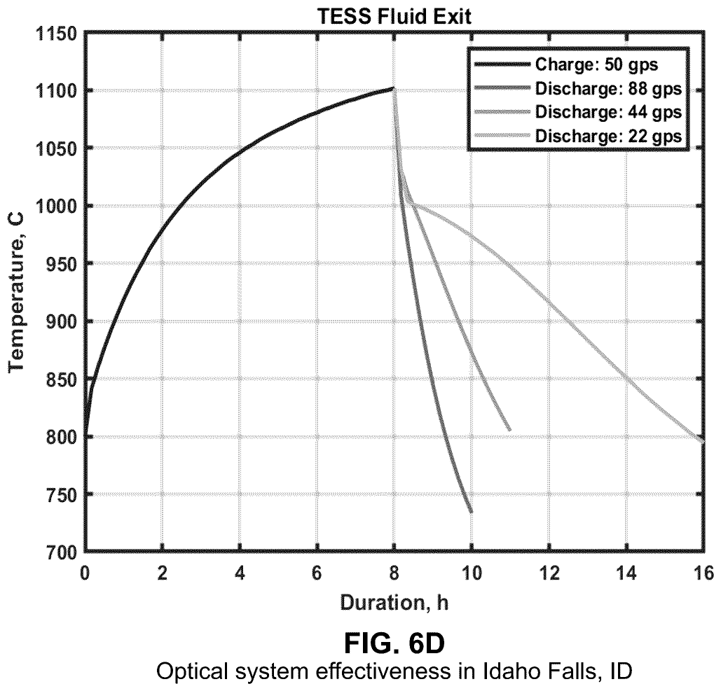

FIGS. 6(A)-6(D) show example sub-system model results.

Using the energy balance shown in FIG. 5, a near-term cost of hydrogen generation will be $1.85 per kg while a long-term cost of hydrogen generation will be $1.50 per kg, averaged across the entire year with a total hydrogen production of 550 kg per year. The results show about 17 to 28% reduction in cost when compared to a similar hydrogen generation system powered solely by grid.

In summary, the example embodiments will be faster to deploy, with a capacity factor of up to 100%, is linearly scalable, and will produce H₂ well within a set target of $2.00 or below.

Example embodiments provide a direct-to-customer solution. Presently, all solution offerings are based on a large-scale centralized hydrogen production facility that requires added infrastructure to deliver to the end-user. With prior art approach(es), even though the cost of hydrogen generation can be reduced to $1.00-$1.50 per kg, the true cost to the customer is still higher. The modularized nature of example embodiments herein is set to transform this market by providing a low-cost distributed hydrogen production plant with a long-term cost target of $1.50 per kg, akin to the distributed battery storage revolution in the residential sector. Considering the footprint requirement of the example non-limiting optical system, the initial market is targeted towards remote end users, such as small-scale fertilizer, steel, and process plants. The dependence of the direct solar resource is the only significant barrier for widespread adoption. However, with the combination of long-duration storage capabilities and the ongoing flooding of the low-cost renewable energy on the grid it is just a few years away from exploding to all sectors of the market.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A system comprising:
a solar heating stage providing a medium heated by solar energy;
a heat exchanger thermally-coupled to receive the heated medium, the heat exchanger using the heated medium to generate steam;
a thermal engine thermally connected to receive the heated medium, the thermal engine generating electricity in response to the heated medium; and
an electrolyzer coupled to the heat exchanger and to the thermal engine, the electrolyzer using the electricity generated by the thermal engine to electrolyze the steam.

2. The system of claim 1 wherein the electrolyzer comprises an SOEC.

3. The system of claim 1 further comprises a separator connected to the electrolyzer, the separator separating hydrogen gas from water output by the electrolyzer, the separated water being directed to the heat exchanger.

4. The system of claim 3 including a further heat exchanger that removes heat from the hydrogen gas and water.

5. The system of claim 3 further including a compressor that compresses the separated hydrogen gas.

6. The system of claim 1 further including ducting that supplies the heated medium to the electrolyzer, and supplies the heated medium after passing through the electrolyzer to the thermal engine.

7. The system of claim 1 further including a thermal storage connected between the solar heating stage and the heat exchanger.

8. The system of claim 1 further including second heating stage thermally coupled to receive the heated medium, the second heating stage further heating the heated medium output to provide a cumulatively heated medium to the heat exchanger.

9. The system of claim 8 wherein the heating stage and the second heating stage each comprise solar heating stages of a continuous solar heat absorber.

10. The system of claim 1 comprising a further heat exchanger that removes heat from oxygen gas generated by the electrolyzer.

11. A method comprising:
providing a medium heated by solar energy;
using the heated medium to generate steam;
generating electricity in response to the heated medium; and
using the generated electricity to electrolyze the steam.

12. The method of claim 11 wherein the electrolyzer comprises an SOEC.

13. The method of claim 11 further comprising separating hydrogen gas from water and using the separated water to generate more steam.

14. The method of claim 13 including removing heat from the hydrogen gas and water.

15. The method of claim 13 further including compressing the separated hydrogen gas.

16. The method of claim 11 further including ducting that supplies the heated medium to the electrolyzer, and supplying the heated medium after passing through the electrolyzing to genreate electricity.

17. The method of claim 11 further including storing heat in a thermal storage connected between the solar heating and the steam generation.

18. The method of claim 11 further including cumulatively heating the heated medium with multiple solar heating stages.

19. The method of claim 11 further comprising removing heat from oxygen gas generated by the electrolyzing.
